(19) United States
(12) Patent Application Publication
(10) Pub. No.: US 2008/0136811 A1
(43) Pub. Date: Jun. 12, 2008

(54) Image displaying system

(76) Inventor: Oluwaseun Adedayo, London (GB)

Correspondence Address: WASSERMAN, COMDEN & CASSELMAN, L.L.P., 5567 RESEDA BOULEVARD, SUITE 330, TARZANA, CA, 91357-7033, US

(21) Appl. No.: 11/567,729

(22) Filed: Dec. 6, 2006

(51) Int. Cl. G06T 15/00

(52) U.S. Cl. 345/419; 345/581

(57) ABSTRACT

An image display system is provided. The image display system is comprised of an image display device and an image generating process. The image displaying system generates an at least one second image, including a at least one second hairstyle after receiving a at least one first image, including the first hairstyle, from a subject. The image display system is mounted at a necessary level, on a surface, such as a wall opposite to a hairstylist's chair. The at least one digital image displaying device captures the subject and displays the at least one first image, including the first hairstyle on the interface. The image generating process, generates a plurality of selective factors from the at least one first image, including the first hairstyle. The image generating process, accesses an at least one database, containing a plurality of hairstyle image data. The subject selects a single, subset or set of hairstyles, retrieving from the at least one database hairstyle image data. The image generating process displays the single, subset or set of hairstyles of the plurality of hairstyle image data. The at least one second image, including the at least one second hairstyle is displayed, containing the plurality of selective factors.

### BACKGROUND OF THE INVENTION

1) Field of the Invention

The invention relates to displaying selected hairstyles on an individual.

2) Discussion of the Related Art

Individuals spend billions of dollars a year into the salon industry. In the United States alone, the salon industry is a $45 billion dollar industry. Many people, after spending money on a haircut at a salon, report having second thoughts, and generally refer to getting a haircut as a “hit or miss.” Many times an individual has chosen a hairstyle from a celebrity or model, only to later find out that that the hairstyle looks good on the celebrity or model, but not on them. There are no formulas to finding the perfect hairstyle, however, because face shape and hair characteristics of an individual are instrumental in the types of hairstyles that individual is able to wear, these features must be analyzed and portrayed so that individual can make a educated choice.

Currently, technology has the ability to generate an image with a selected hairstyle on an individual, allowing the individual to view that hairstyle before the actual haircut. To do this, current inventions superimpose the selected hairstyle on the individual. Many inventions synthesize selected hair and subject image by employing a smoothing function or marking a plurality of points, when attaching the hairstyle to the head of the individual. However, this presupposes that every hairstyle fits every individual, which is far from true.

The current art is unable to portray the selected hairstyle and subject in any realistic manner. Each individual has different facial and hair characteristics that may or may not accommodate a selected style. Hairstyles need to fit the characteristics of the individual. In generating an image with a selected style, the image must be generated in real time. This will give the individual an accurate portrayal and a firm decision on whether or not to proceed with the selected hairstyle.

### BRIEF DESCRIPTION OF THE DRAWINGS

The invention is described by way of example with reference to the accompanying drawings wherein:

FIG. 1 is a front perspective view of an image display device of an image display system.

FIG. 2 is a rear view of the image display device of the image display system.

FIG. 3 is a side view of the image display device of the image display system, mounted to a surface.

FIG. 4 is a flow chart of an image generating process of the image display system.

FIG. 5 is an illustration of an intersection of three planes within an individual head, providing coordinates of selected points.

### DETAILED DESCRIPTION OF THE INVENTION

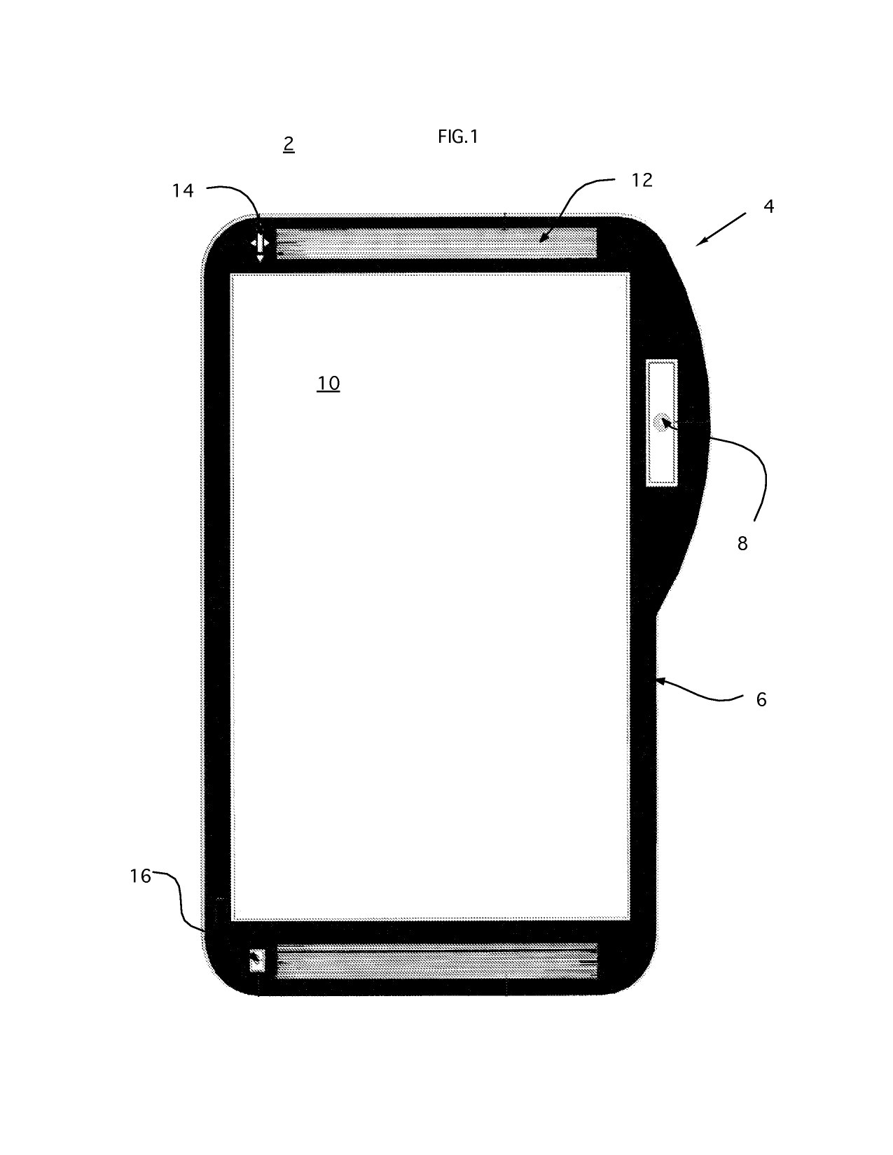

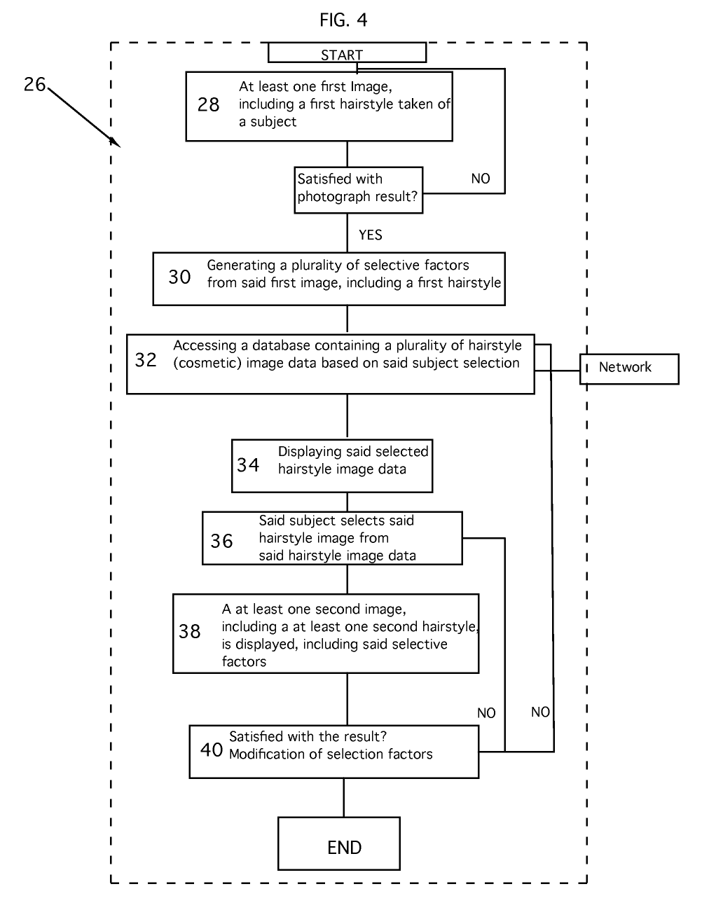

FIG. 1 of the accompanying drawings illustrates an image displaying system 2. The image displaying system 2 includes an image displaying device 4 and an image generating process 26, seen in FIG. 4. The image display system 2 may be implemented, including a variety of components that communicate over a public network, to the Internet. The image displaying system 2, accesses web servers and databases through, in one embodiment, over a local area network (LAN), or an Internet service provider (ISP).

The image displaying device 4, includes a housing 6, an at least one digital image capturing device 8, an interface 10, a plurality of sound devices 12, an at least one manual control button 14 and a power button 16. The image displaying device 4 typically includes one or more processors, memories and input/output devices.

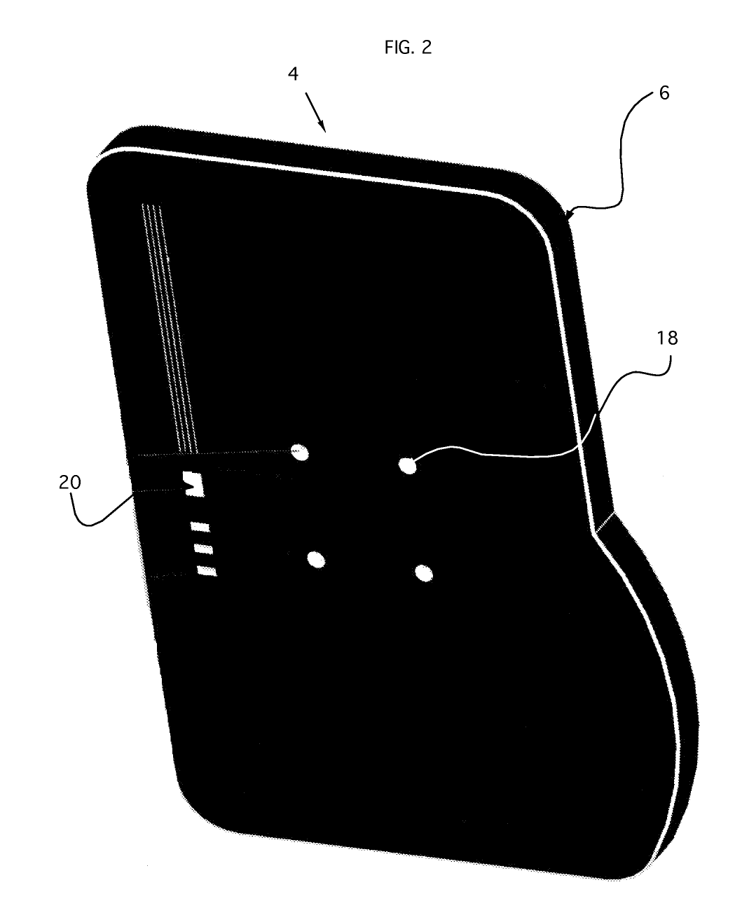

FIG. 2 of the accompanying drawings illustrates a rear view of the image displaying device 4, including plurality of attachment elements 18 and a means for connecting to a network 20. The means for connecting to a network or central processing unit include a plurality of Universal Serial Bus (USB) connections, wireless cards or connectors, telephone jack and a Firewire™ port.

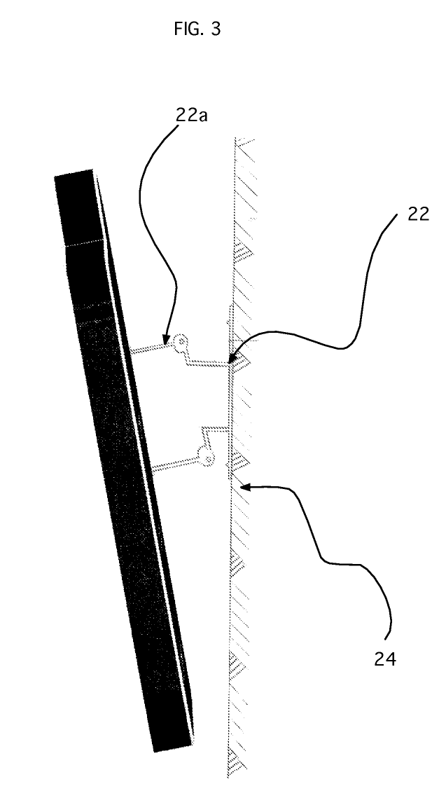

FIG. 3 of the accompanying drawings illustrates a side view of the image display device 4. The plurality of attachment elements 18, contact a wall-mounted bracket 22 via a plurality of interconnection elements 22a, which secure the image display system 2 to a surface 24.

FIG. 4 of the accompanying drawings illustrates the image generating process 26. The image generating process 26 is comprised of a means for generating an at least one second image of a subject, including an at least one second hairstyle 38, from an at least first image, including a first hairstyle of the subject 28. The image generating process 26, generates a plurality of selective factors 30 from the at least one first image, including the first hairstyle 28. The plurality of selective factors 30 may be characteristics associated with the subject, including facial and hair characteristics.

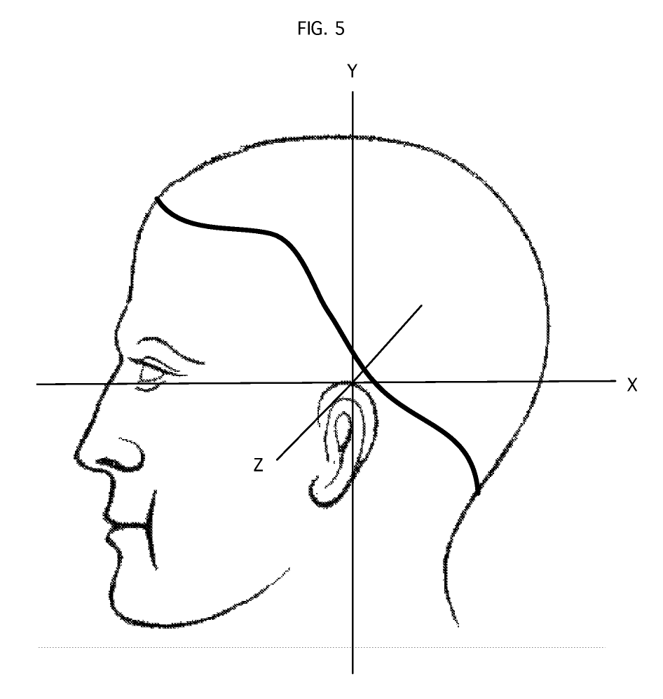

FIG. 5 of the accompanying drawings illustrates a generation of coordinate points on x, y and z planes, based on selected facial and hair points. The image generating process 26 accesses an at least one database 32 containing a plurality of hairstyle image data. The subject selects a single, subset or set of hairstyles. The image generating process 26 displays the selected single, subset or set of hairstyles. The at least one second hairstyle 38 is displayed after the subject selects from the selected single, subset or set. The at least one second image, including the at least one second hairstyle 38 is displayed, containing the plurality of selective factors 30 within the image.

In use, the image displaying system 2 generates the at least one second image, including the at least one second hairstyle 38 after receiving the at least one first image, including the first hairstyle 28, from the subject. The image display system 2, in one embodiment, is mounted to a surface, such that the subject visiting a haircut facility can sit down and provide the first image, including the first hairstyle 28 to the image display system 2. In one embodiment the image display system 2 is mounted at a necessary level, on a surface, such as a wall 24 opposite to a hairstylist's chair. The image display system 2 includes the plurality of attachment elements 18 which contact the wall-mounted bracket 22 via a plurality of interconnection elements 22a, securing the image display system to a surface 24. The image display system 2, in one embodiment, includes the plurality of sound devices 12 in embodiments where a sound file is downloaded from the at least one database 32.

The at least one digital image capturing device 8, within the housing 6, captures the subject and displays the at least one first image, including the first hairstyle 28 on the interface 10. In one embodiment, the at least one digital image capturing device 8, captures a plurality of the at least first image, including the first hairstyle 28, generating a three dimensional rendering

If the subject is satisfied with the at least one first image, the image generating process 26, generates a plurality of selective factors 30 from the at least one first image, including the first hairstyle 28 The plurality of selective factors 30 are characteristics associated with the subject. In one embodiment, the plurality of selective factors 30 are generated by analyzing the subjects facial and hair features on a y-axis, x-axis and z-axis. Facial features comprise head shape and hair demarcation to selected points on a face, such as distances from a sideburn and a hairline to a midline of a jaw, a corner of a mouth, nose, chin, cheek bone, ears and eyes.

In another embodiment, the plurality of selective factors 30 are generated from an analysis of the subjects hair, comprising: hair density, hair type, including coarse, fine, wavy, kinky, smooth, fly away, oily, thin, thick, shiny, dry, curly, brittle, frizzy, patchy and normal. The image generating process 26, including a sensor, a processor and a set algorithms, calculating hair density (n/cm²), including hair diameter (μm), hair thickness, including calculation of a number of hairs to a region, in generating the at least one second image, including the at least one second hairstyle 38. In another embodiment, the plurality of selective factors 30 include subjects skin color, tone and type.

The image generating process 26 then accesses a plurality of hairstyle image data from an at least one database 32. Hairstyle image data comprises hair color, length, type and celebrity styles. Hairstyle image data can be sorted in many ways for ease of searching, as well as display. In one embodiment, the at least one database 32 is a plurality. In another embodiment the at least one database 32 contains content directed to cosmetic make-up images, tailored to selective factors generated from the subjects skin color, tone and type. In another embodiment, the at least one database 32 can be connected to a network, wirelessly, and updated.

The subject selects a single, subset or set of hairstyles, retrieving from the at least one database 32 hairstyle image data. The image generating process 26 displays the single, subset or set of hairstyles of the plurality of hairstyle image data. In one embodiment, the means for displaying the plurality of hairstyle image data is in short list form. The subject selects the at least one second hairstyle from the hairstyle image data. In one embodiment, the subject or a stylist can select the at least one second hairstyle from the image data via a remote control. In another embodiment, the at least one second hairstyle can be selected via at least one manual control button 14 on the image display device 2. The at least one second image, including the at least one second hairstyle 38 is displayed, containing the plurality of selective factors 30. In one embodiment, the subject can modify the at least one second hairstyle by varying selection factors.

Many times an individual has chosen a hairstyle from a celebrity or model, only to later find out that that the hairstyle does not fit the individual. The present invention provides the at least one second image, including the at least one second hairstyle 38 using real time information generated from the at least first image, including a first hairstyle of the subject 28. An advantage of the present invention is the use of real time information in the at least one second image, including a first hairstyle 38, illustrating how the selected hairstyle will look given their current hair characteristics and face shape. Each individual has different facial and hair characteristics that may or may not accommodate a selected style. If the individual has thick wavy hair or is going bald, the selected hairstyle will include those features. Thus, the individual will receive an accurate portrayal and a firm decision on whether or not to proceed with the selected hairstyle.

An advantage of the invention is the ability to access a wide variety of hairstyles on a consistently updated database, which monitors new styles and trends. In addition, the invention contains a variety of cosmetic features, including make-up. The hairstyle data may be in short list form or searchable by color, celebrity or style, and a multitude of other hair characteristics, including length and type. The hairstyles may also be displayed, according to modifications, including color dyes and/or bleaching. The individual is then able select and display those featured hairstyles, and if chosen, the possible associated enhanced characteristics.

Generally an individual has a select style, however there are instances where the individual is seeking to expand styles and would benefit from a comparison. An advantage of the invention is the ability to generate a plurality of images of selected hairstyles on the interface of the system, providing the individual an overall view of a set of selected styles on the individual's image. Another advantage of the invention is that the selected images may be rendered in three dimensions, providing the individual with all possible angles. After a final selection, the hairstyle and subject image may be rendered in three dimensions.

While certain exemplary embodiments have been described and shown in the accompanying drawings, it is to be understood that such embodiments are merely illustrative and not restrictive of the current invention, and that this invention is not restricted to the specific constructions and arrangements shown and described since modification may occur to those ordinarily skilled in the art.

1. A computer readable medium, useful in association with a computer, said computer including a processor, memory and an interface, said computer readable medium including a set of instructions configured to modify an image, comprising:
generating a at least one image of a subject;
generating a modified image of said subject, including a at least a first image data, comprising:
generating a plurality of selective factors from said at least one image; accessing a at least one database, said at least one database containing a plurality of image data;
retrieving said plurality of image data from said at least one database;
displaying said plurality of image data;
selecting said at least a first image data, of said plurality of image data; and
displaying said modified image, including said at least a first image data on said subject, including said plurality of selective factors.

2. The computer readable medium of claim 1, wherein said plurality of image data is comprised of hairstyle and cosmetic image data.

3. The computer readable medium of claim 1, including displaying said modified image, including a plurality of selections from said plurality of image data.

4. The computer readable medium of claim 1, including modifying said at least a first image data on said subject.

5. The computer readable medium of claim 1, wherein said at least one image of said subject is generated in three dimensions.

6. A image displaying system, said image displaying system comprising at least one server computer for communicating with a at least one client computer, comprising:
a housing, including a at least one digital image displaying device, an interface, a at least one database, said at least one database including a plurality of image data, said at least one digital image displaying device, producing a at least one image of a subject;
means for generating a modified image of said subject, including a at least a first image data, comprising:
means for generating said at least one image of a subject:
means for generating a plurality of selective factors from said at least one image;
means for accessing a at least one database, said at least one database containing said plurality of image data;
means for retrieving said plurality of image data from said at least one database;
means for displaying said plurality of image data;
means for selecting said at least a first image data, of said plurality of image data; and means for displaying said modified image, including said at least a first image data on said subject, including said plurality of selective factors.

7. The image displaying system claim 6, wherein said plurality of image data is comprised of hairstyle and cosmetic image data.

8. The image displaying system of claim 6, including said means for displaying said modified image, including a plurality of selections from said plurality of image data.

9. The image displaying system of claim 6, including a means for modifying said at least a first image data on said subject.

10. The image displaying system claim 6, wherein said at least one image of said subject is generated in three dimensions.

11. The image display system of claim 6, wherein said means for accessing said at least one database is wireless.

12. The image display system of claim 6, where said image display system is secured to a surface, including a wall-mounted bracket, contacting a plurality of attachment elements, though a plurality of interconnection elements.

13. The image display system of claim 12, including a plurality of sound devices.

14. The image display system of claim 13, including an at least one manual control button and a remote control access.

15. A method of modifying an image, comprising:
producing a at least one image of a subject, by a at least one image displaying device, said image displaying device, including, a housing, at least one digital image displaying device, an interface, a plurality of sound devices, a at least one manual control button, a means for connecting to a network, a at least one database, said at least one database including a plurality of image data;
generating a at least one image of a subject;
generating a modified image of said subject, including a at least a first image data, comprising:
generating a plurality of selective factors from said at least one image;
accessing a at least one database, said at least one data base containing a plurality of image data;
retrieving said plurality of image data from said at least one database;
displaying said plurality of image data;
selecting said at least a first image data, of said plurality of image data; and displaying said modified image, including said at least a first image data on said subject, including said plurality of selective factors.

16. The method of claim 15, wherein said plurality of image data is comprised of hairstyle and cosmetic image data.

17. The method of claim 15, including displaying said modified image, including a plurality of selections from said plurality of image data.

18. The method of claim 15, including modifying said at least a first image data on said subject.

19. The method of claim 15, wherein said at least one image of said subject is generated in three dimensions.

20. The method of claim 15, wherein said means for accessing said at least one database is wireless.
